(19) United States
(12) Patent Application Publication
(10) Pub. No.: US 2024/0407375 A1
(43) Pub. Date: Dec. 12, 2024

(54) STUFFING FOOD FORMING APPARATUS

(71) Applicant: ANKO FOOD MACHINE CO., LTD., New Taipei City (TW)

(72) Inventors: JYUN-SHIH CHEN, New Taipei City (TW); JUI-FENG CHU, New Taipei City (TW)

(21) Appl. No.: 18/224,055

(22) Filed: Jul. 19, 2023

(30) Foreign Application Priority Data
Jun. 9, 2023 (TW) 112205885

(51) Int. Cl. A21C 9/06

(52) U.S. Cl. CPC A21C 9/063; A21C 9/061

(57) ABSTRACT

Provided is a stuffing food forming apparatus, the flipping units are utilized to replace the wrapping operation of the wrapper used in the rolling method in the prior art. The shape of non-strip stuffing can be maintained to a large extent, and the technical problems encountered in the automation of plate-shaped stuffing foods are solved.

### FIELD OF THE INVENTION

The present invention relates to a stuffing food forming apparatus, and more particularly, applied in food processing machinery, to solve the technical issue that the stuffing food forming mechanism cannot handle the forming of square stuffings.

### BACKGROUND OF THE INVENTION

In the prior art, as regarding the forming apparatus for spring rolls, since the stuffings are mostly strips, the forming process is mostly as follows: providing the wrapper; placing the strip of stuffing on the wrapper; folding the first side of the wrapper on the long side of the stuffing toward the stuffing; folding the second side and the third side of the wrapper on the short sides of the stuffing toward the stuffing; then, rolling it in the direction of the fourth side of the wrapper to form the general-shaped spring roll.

However, as the shape of the stuffing is not a stripe, such as a square plate or other shapes that are not suitable for rolling, the stuffing may be greatly deformed after the rolling process if the rolling method is adopted.

Thus, there is a need to provide a stuffing food forming apparatus to solve the foregoing technical issue of the prior art.

### SUMMARY OF INVENTION

For solving the foregoing technical issue of the prior art, the present invention utilizes the flipping units to replace the wrapping operation of the wrapper used in the rolling method in the prior art. The shape of non-strip stuffing can be maintained to a large extent, and the technical problems encountered in the automation of plate-shaped stuffing foods are solved.

An objective of the present invention is to provide a stuffing food forming apparatus, comprising a wrapper receiving area, a main conveyor belt, a stuffing feeder, two side folding plates and two flipping units. The wrapper receiving area is employed for receiving a wrapper. The main conveyor belt transports the wrapper in a first direction. The stuffing feeder is employed to extrude a stuffing onto the wrapper when the main conveyor belt transports the wrapper to the stuffing feeder. The two side folding plates are employed to respectively fold a first part and a second part of the wrapper, which are perpendicular to the first direction, toward the stuffing when the main conveyor belt transports the wrapper to the two side folding plates. Each of the two flipping units comprises a set of protrusions and at least one flipping hook. The set of protrusions abuts against the wrapper, and the at least one flipping hook flips the wrapper upward and then toward an opposite direction of the first direction with the set of protrusions as a pivot when the main conveyor belt transports the wrapper to one of the two flipping units.

In a preferred embodiment, a pre-pressor is further arranged behind the two side folding plates on the main conveyor belt for pressing the wrapper so that at least one pressed mark perpendicular to the first direction is formed on the wrapper.

In a preferred embodiment, the at least one flipping hook cooperates with the set of protrusions of one of the two flipping units sequentially abutting against the at least one pressed mark to flip the wrapper upward and then toward an opposite direction of the first direction.

In a preferred embodiment, the main conveyor belt comprises a plurality of sub-conveyor belts, and there is a groove between every two of the plurality of sub-conveyor belts for receiving the at least one flipping hook.

In a preferred embodiment, the set of protrusions are arranged on both sides of the main conveyor belt, and the pair of protrusions move toward the wrapper to contact the wrapper when the wrapper is transported to the two flipping units.

In a preferred embodiment, a shaping unit is further arranged after the two flipping units on the main conveyor belt to flatten the wrapper and make the stuffing evenly distributed in the wrapper.

In a preferred embodiment, set of protrusions of each of the two flipping units move toward the wrapper from both sides of the main conveyor belt perpendicular to the first direction to abut against the wrapper when the main conveyor belt transports the wrapper to the two flipping units.

Compared with the prior art, the present invention utilizes the flipping units to replace the wrapping operation of the wrapper used in the rolling method in the prior art. The shape of non-strip stuffing can be maintained to a large extent, and the technical problems encountered in the automation of plate-shaped stuffing foods are solved.

### BRIEF DESCRIPTION OF THE ACCOMPANYING DRAWINGS

FIG. 1 depicts a diagram of an entire machine of a stuffing food forming apparatus according to the present invention;

FIG. 2 depicts a top diagram of an entire machine of a stuffing food forming apparatus according to the present invention;

FIG. 3 depicts a forming sequence diagram of a stuffing food according to the present invention;

FIG. 4 depicts a side view diagram of a wrapper passing through pre-pressor of the stuffing food forming apparatus according to the present invention; and

FIGS. 5-8 depict operation diagrams of the flipping unit shown in FIG. 1.

### DETAILED DESCRIPTION OF PREFERRED EMBODIMENTS

The following descriptions of the embodiments refer to the appended figures to illustrate specific embodiments in which the present invention may be implemented. The directional terms of up, down, front, rear, left, right, interior, exterior, side, etcetera mentioned in the present invention are merely directions of referring to appended figures. Therefore, the aforesaid directional terms are employed for explaining and understanding the present invention, but the present invention is not limited thereto.

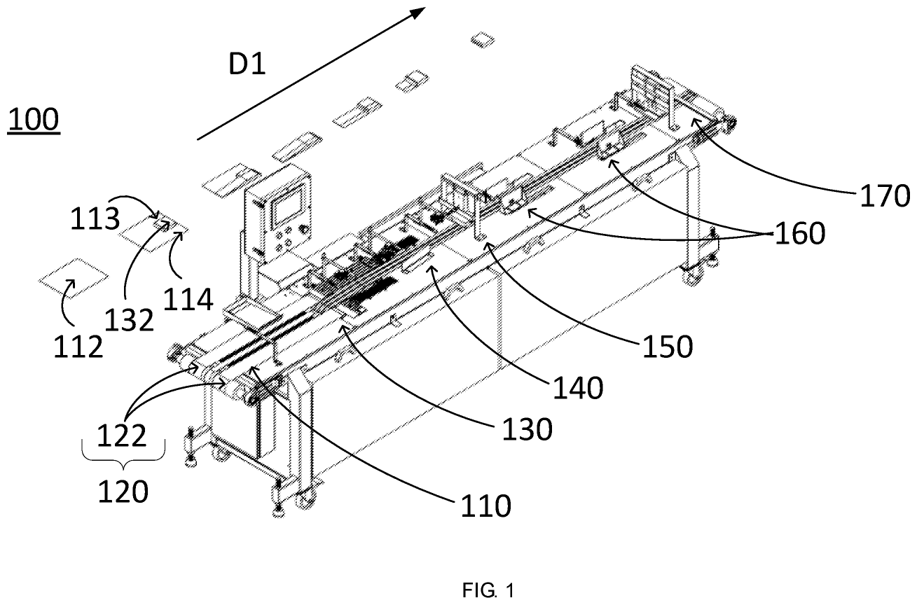

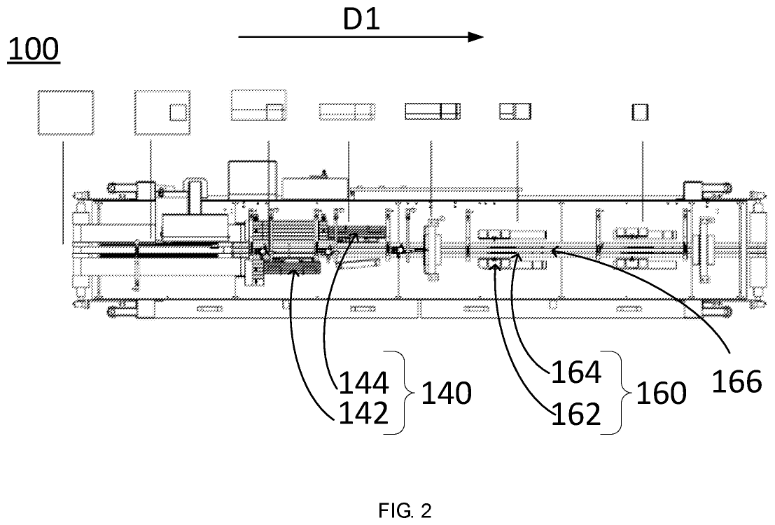

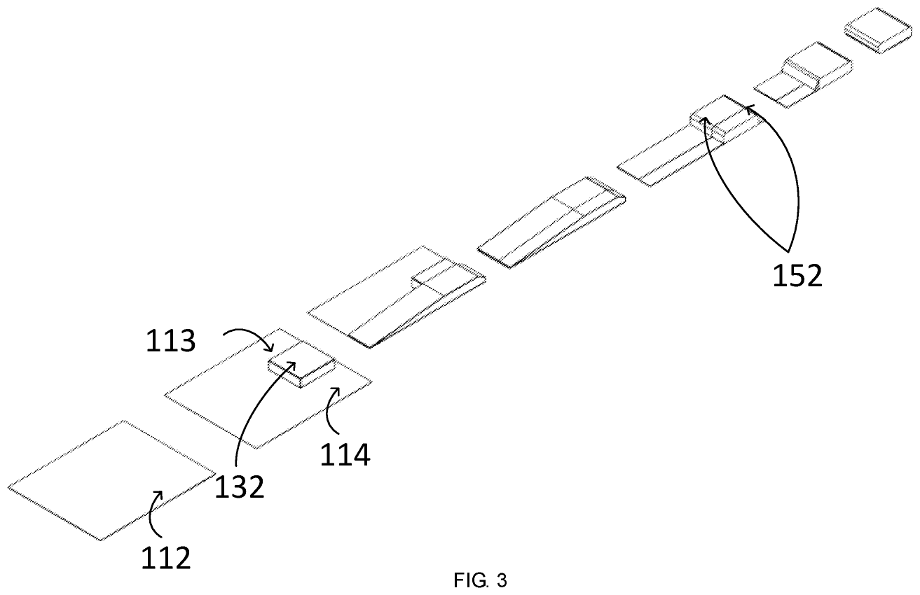

Referring to FIGS. 1-4, FIG. 1 depicts a diagram of an entire machine of a stuffing food forming apparatus 100 according to the present invention; FIG. 2 depicts a top diagram of an entire machine of a stuffing food forming apparatus 100 according to the present invention; FIG. 3 depicts a forming sequence diagram of a stuffing food according to the present invention; FIG. 4 depicts a side view diagram of a wrapper passing through pre-pressor of the stuffing food forming apparatus according to the present invention. The tops of FIG. 1 and FIG. 2 show the shapes of stuffing food corresponding to each station for explanation. The stuffing food forming apparatus 100 comprises a wrapper receiving area 110, a main conveyor belt 120, a stuffing feeder 130, two side folding plates 140, a pre-pressor 150, two flipping units 160 and a shaping unit 170.

The wrapper receiving area 110 is employed for receiving a wrapper 112. The main conveyor belt 120 transports the wrapper 112 in a first direction D1. The stuffing feeder 130 is employed to extrude a stuffing 132 onto the wrapper 112 when the main conveyor belt 120 transports the wrapper 112 to the stuffing feeder 130. In detail, the stuffing 132 will fall in the middle.

The two side folding plates 140 are employed to respectively fold a first part 114 and a second part 113 of the wrapper 112, which are perpendicular to the first direction D1, toward the stuffing 132 when the main conveyor belt 120 transports the wrapper 112 to the two side folding plates 140. In detail, the two side folding plates 140 are divided into two sets. The first side folding plate 142 is disposed on the right side along the first direction D1. When the wrapper 112 is transported to the first side folding plate 142, the first side folding plate 142 will rotate 90 degrees, thus moving the first part 114 to the left to cover the stuffing 132; the second side folding plate 144 is disposed on the left side along the first direction D1. When the wrapper 112 is transported to the second side folding plate 144, the second side folding plate 144 will rotate 90 degrees, thus moving the second part 113 to the right to cover the stuffing 132. In detail, both the two side folding plates 140 possess an inclined surface at the part close to the stuffing feeder 130, so that the wrapper 112 can be transported by the main conveyor belt 120 to move the first part 114 and the second part 113 to the top of the two side folding plates 140 for folding operations. For instance, the two side folding plates 140 are two panels.

The pre-pressor 150 is arranged behind the two side folding plates 140 on the main conveyor belt 120 for pressing the wrapper 112 so that at least one pressed mark 152 perpendicular to the first direction D1 is formed on the wrapper 112. Preferably, the contact of the pre-pressor 150 to the wrapper 112 will be indentations (it appears in the inverted U type from the lateral side as shown in FIG. 4) to generate two corresponding pressed marks 152.

In this preferred embodiment, before the pre-pressor 150 contacts the wrapper 112, the wrapper 112 has been folded twice. Thus, pressing at this time can allow the stuffing 132 to form a predetermined shape. Although the stuffing 132 can have a specific shape as being extruded from the stuffing feeder 130, the shape of the stuffing may be slightly changed through the action of the two side folding plates 140, so it can be further shaped by the pre-pressor 150.

In detail, in this preferred embodiment, the pre-pressor 150 generates two pressed marks 152. The purpose there of is to allow the stuffing 132 to be squeezed between the two pressed marks 152 according to the amount of the stuffing 132 and the predetermined shape of the product, so as to prevent the problem with stuffing falling out after the subsequent flippings. Preferably, the pre-pressor 150 is an indentation in order to press down the wrapper 112 near the stuffing 132 to make the folds look nice.

Each of the two flipping units 160 comprises a set of protrusions 162 and at least one flipping hook 164. The set of protrusions 162 abuts against the wrapper 112, and the at least one flipping hook 164 flips the wrapper 112 upward and then toward an opposite direction of the first direction D1 with the set of protrusions 162 as a pivot when the main conveyor belt 120 transports the wrapper 112 to the two flipping units 160. In detail, the first flipping of the flipping units 160 is based on the pivot axis of the pressed mark 152 at the rear (along the first direction D1), that is, the flipping is performed with the set of protrusions 162 abutting against the pressed mark 152; the second flipping of the flipping units 160 is based on the pivot axis of the pressed mark 152 (this pressed mark 152 is also behind stuffing 132 after the first flipping) at the front (along the first direction D1), that is, the flipping is performed with the set of protrusions 162 abutting against the pressed mark 152. Referring to FIG. 4, in detail, the flipping unit 160 further comprises a sensor. It can be judged that the wrapper 112 has reached the predetermined position according to the thickness (the pressed mark 152 on the right), and the flipping hook 164 is actuated.

Preferably, the main conveyor belt 120 comprises a plurality of sub-conveyor belts 122, and there is a groove 166 between every two of the plurality of sub-conveyor belts 122 for receiving the at least one flipping hook 164. In this preferred embodiment, considering the balance and the size of the final product, two flipping hooks 164 (received in the two grooves 166 between the three sub-conveyor belts 122) are provided. However, the size and quantity of the flipping hooks 164 can also be adjusted according to different requirements.

In detail, the set of protrusions 162 are arranged on both sides of the main conveyor belt 120, and the pair of protrusions 162 move toward the wrapper 112 to contact the wrapper 112 when the wrapper 112 is transported to the two flipping units 160. The set of protrusions 162 of each of the two flipping units 160 move toward the wrapper 112 from both sides of the main conveyor belt 120 perpendicular to the first direction D1 to abut against the wrapper 112 when the main conveyor belt 120 transports the wrapper 112 to the two flipping units 160.

In this preferred embodiment, on the premise of giving an appropriate length (along the first direction D1), the wrapper 112 (including the stuffing 132) needs to be flipped twice in the first direction D1, so two flipping units 160 are provided.

The shaping unit 170 is employed to flatten the wrapper 112 and make the stuffing 132 evenly distributed in the wrapper 112. Preferably, the shaping unit 170 is a flat plate for flattening the appearance.

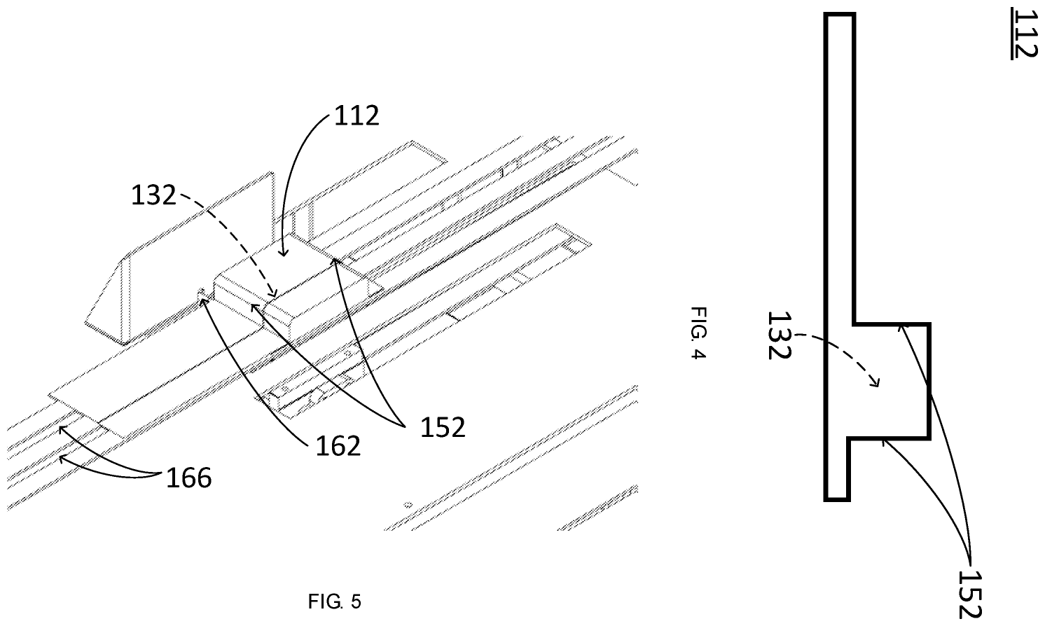

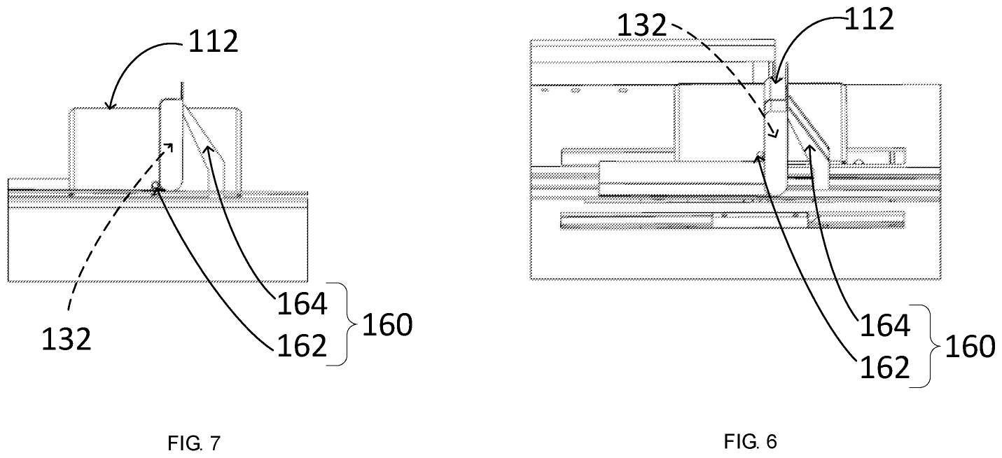

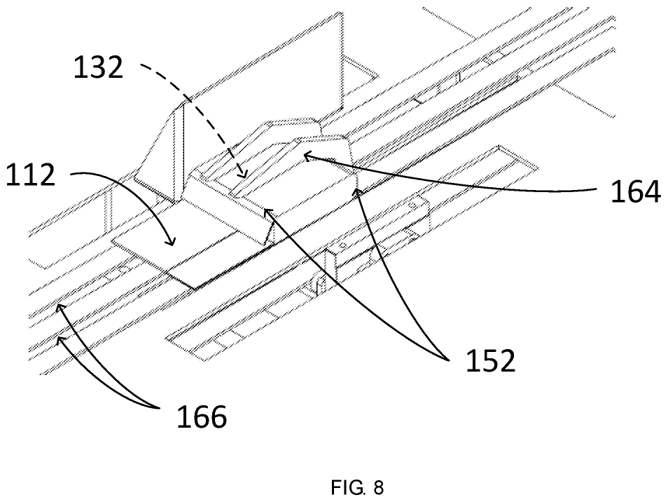

FIGS. 5-8 depict operation diagrams of the flipping unit 160 shown in FIG. 1. FIG. 5 depicts a perspective view diagram that the flipping unit 160 has not yet been operated; FIG. 6 depicts a perspective view diagram that the flipping unit 160 is operated halfway; FIG. 7 depicts a lateral view diagram showing a status that the flipping unit 160 is operated halfway; FIG. 8 depicts a perspective view diagram that the operation of the flipping unit 160 is accomplished. Please refer to FIGS. 1-4 for component symbols mentioned below, and will not be repeated here. The arrow used to mark the stuffing 132 here is a dotted line, which is employed to indicate that the stuffing 132 is inside the wrapper 112.

First, after the wrapper 112 carrying the stuffing 132 has been wrapped twice by the two side folding plates 140 and then, entering the area of the flipping units 160, the set of protrusions 162 will approach to the pressed mark 152 of the wrapper 112; then, the flipping hooks 164 rotate to drive the wrapper 112 for flipping; finally, the flipping hook 164 flips the wrapper 112 (the part carrying the stuffing 132), so as to realize the objective of wrapping the stuffing 132 inside the wrapper 112 along the first direction D1. Accordingly, with prior wrapping the stuffing 132 inside the wrapper 112 perpendicular to the first direction D1 by the side folding plates 140, the stuffing 132 can be wrapped by the wrapper 112 in four directions to form a spring roll structure. In this preferred embodiment, the front and back sides along the first direction D1 are wrapped by two sets of flipping units 160 to prevent the stuffing 132 from leaking out.

Compared with the prior art, the present invention utilizes the flipping units to replace the wrapping operation of the wrapper used in the rolling method in the prior art. The shape of non-strip stuffing can be maintained to a large extent, and the technical problems encountered in the automation of plate-shaped stuffing foods are solved.

Above are only preferred embodiments of the present invention, and it should be noted that to any persons who are skilled in the art, improvement and modification which is easily derived should be covered by the protected scope of the application. Thus, the protected scope of the application should go by the subject claims, including the improvement and the modification.

What is claimed is:

1. A stuffing food forming apparatus, comprising:
a wrapper receiving area, receiving a wrapper;
a main conveyor belt, transporting the wrapper in a first direction;
a stuffing feeder, employed to extrude a stuffing onto the wrapper when the main conveyor belt transports the wrapper to the stuffing feeder;
two side folding plates, employed to respectively fold a first part and a second part of the wrapper, which are perpendicular to the first direction, toward the stuffing when the main conveyor belt transports the wrapper to the two side folding plates; and
two flipping units, each of which comprises a set of protrusions and at least one flipping hook, and the set of protrusions abuts against the wrapper, and the at least one flipping hook flips the wrapper upward and then toward an opposite direction of the first direction with the set of protrusions as a pivot when the main conveyor belt transports the wrapper to one of the two flipping units.

2. The stuffing food forming apparatus according to claim 1, wherein a pre-pressor is further arranged behind the two side folding plates on the main conveyor belt for pressing the wrapper so that at least one pressed mark perpendicular to the first direction is formed on the wrapper.

3. The stuffing food forming apparatus according to claim 2, wherein the at least one flipping hook cooperates with the set of protrusions of one of the two flipping units sequentially abutting against the at least one pressed mark to flip the wrapper upward and then toward an opposite direction of the first direction with the set of protrusions as the pivot.

4. The stuffing food forming apparatus according to claim 1, wherein the main conveyor belt comprises a plurality of sub-conveyor belts, and there is a groove between every two of the plurality of sub-conveyor belts for receiving the at least one flipping hook.

5. The stuffing food forming apparatus according to claim 4, wherein the set of protrusions are arranged on both sides of the main conveyor belt, and the pair of protrusions move toward the wrapper to contact the wrapper when the wrapper is transported to the two flipping units.

6. The stuffing food forming apparatus according to claim 1, wherein a shaping unit is further arranged after the two flipping units on the main conveyor belt to flatten the wrapper and make the stuffing evenly distributed in the wrapper.

7. The stuffing food forming apparatus according to claim 3, wherein a shaping unit is further arranged after the two flipping units on the main conveyor belt to flatten the wrapper and make the stuffing evenly distributed in the wrapper.

8. The stuffing food forming apparatus according to claim 1, wherein the set of protrusions of each of the two flipping units move toward the wrapper from both sides of the main conveyor belt perpendicular to the first direction to abut against the wrapper when the main conveyor belt transports the wrapper to the two flipping units.
